(19) United States
(12) Patent Application Publication
(10) Pub. No.: US 2020/0103572 A1
(43) Pub. Date: Apr. 2, 2020

(54) POLARIZER SUBSTRATE AND MANUFACTURING METHOD THEREOF

(71) Applicant: Au Optronics Corporation, Hsinchu (TW)

(72) Inventors: Wei-Chi Wang, Hsinchu (TW); Chih-Chiang Chen, Hsinchu (TW); Tsai-Sheng Lo, Hsinchu (TW); Sheng-Kai Lin, Hsinchu (TW); Chia-Hsin Chung, Hsinchu (TW); Hui-Ku Chang, Hsinchu (TW); Ming-Jui Wang, Hsinchu (TW); Sheng-Ming Huang, Hsinchu (TW); Jen-Kuei Lu, Hsinchu (TW)

(73) Assignee: Au Optronics Corporation, Hsinchu (TW)

(21) Appl. No.: 16/411,162

(22) Filed: May 14, 2019

(30) Foreign Application Priority Data
Oct. 1, 2018 (TW) 107134630

(51) Int. Cl. G02B 5/30; G02B 5/20

(52) U.S. Cl. CPC G02B 5/3025; G02B 5/20

(57) ABSTRACT

A polarizer substrate and manufacturing method thereof are provided. The polarizer substrate includes a substrate, a plurality of polarizer structures, a plurality of barrier structures, and a passivation layer. The polarizer structures are disposed on the substrate. Each of the polarizer structures includes a wire-grid and a capping structure disposed on the wire-grid. The barrier structures are disposed on the capping structures and not contacting with the side walls of the wire-grids. A gap between two adjacent barrier structures is smaller than a gap between two adjacent wire-grids. The passivation layer is disposed on the barrier structures.

### CROSS-REFERENCE TO RELATED APPLICATION

This application claims the priority benefit of Taiwan application serial no. 107134630, filed on Oct. 1, 2018. The entirety of the above-mentioned patent application is hereby incorporated by reference herein and made a part of this specification.

### BACKGROUND

### Field of the Invention

The invention relates to a polarizer substrate and more particularly, to a polarizer substrate having barrier structures and a manufacturing method thereof.

Description of Related Art

In a liquid crystal display panel, polarizer structures are usually disposed on the upper and lower substrates. The direction of the absorption axis of the polarizer structures is determined through the extension direction of the polarizer structures. Since only the light with the polarization direction perpendicular to the absorption axis of the polarizer structures can pass through the polarizer structures, rotation of the liquid crystal between the upper and lower substrates can be used to adjust whether light is allowed to pass through the liquid crystal display panel. Nevertheless, in order to enable the liquid crystal display panel to provide favorable display quality, how to increase the transmittance and extinction ratio of the polarizer structures is an important issue.

### SUMMARY

The invention provides a polarizer substrate having a high transmittance and a high extinction ratio.

The invention provides a manufacturing method of a polarizer substrate, capable of obtaining a polarizer substrate having a high transmittance and a high extinction ratio.

At least one embodiment of the invention provides a polarizer substrate, including a substrate, a plurality of strip-shaped polarizer structures, a plurality of barrier structures and a passivation layer. The strip-shaped polarizer structures are disposed on the substrate. Each of the strip-shaped polarizer structures includes a wire-grid and a strip-shaped capping structure disposed on the wire-grid. The barrier structures are disposed on the strip-shaped capping structures and do not contact with side walls of the wire-grids. A gap between two adjacent barrier structures is smaller than a gap between two adjacent wire-grids. The passivation layer is disposed on the barrier structures.

At least one embodiment of the invention provides a manufacturing method of a polarizer substrate, including: forming a wire-grid material layer above a substrate; forming a capping material layer on the wire-grid material layer; forming a patterned photoresist layer on the capping material layer; patterning the capping material layer using the patterned photoresist layer as a mask to form a plurality of strip-shaped capping structures; performing first etching on the wire-grid material layer using the strip-shaped capping structure as a mask; performing second etching on the wire-grid material layer using the strip-shaped capping structure as a mask to form a plurality of wire-grids, and forming a plurality of barrier structures on the strip-shaped capping structures while the second etching is performed, wherein an etching rate of the first etching is greater than an etching rate of the second etching, and a gap between two adjacent barrier structures is smaller than a gap between two adjacent wire-grid.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A through FIG. 1E are schematic cross-sectional views of a manufacturing method of a polarizer substrate according to an embodiment of the invention.

### DESCRIPTION OF EMBODIMENTS

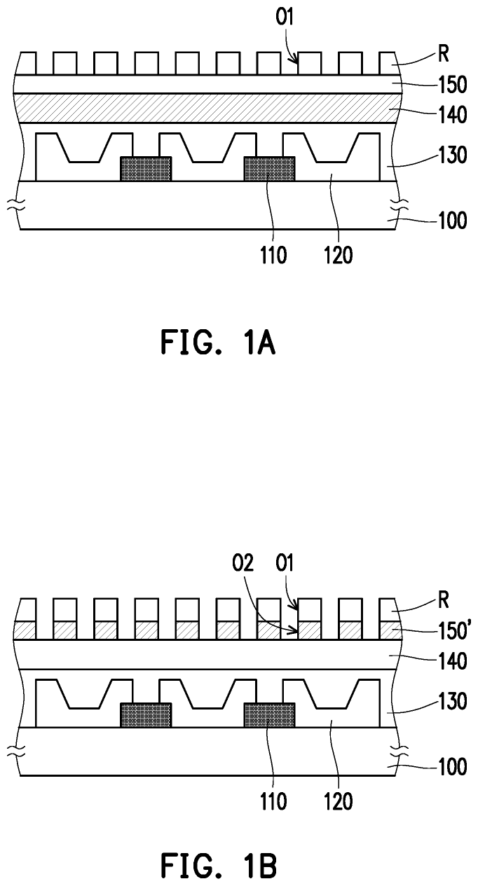

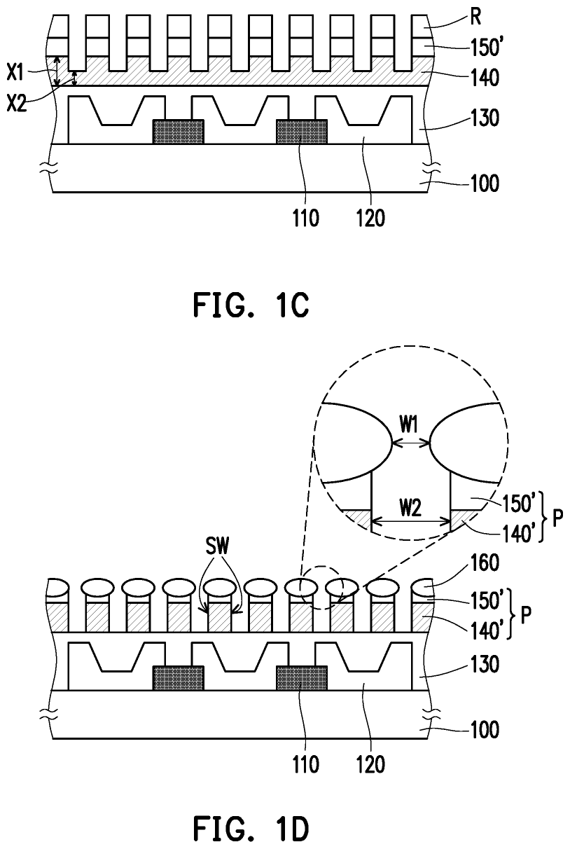

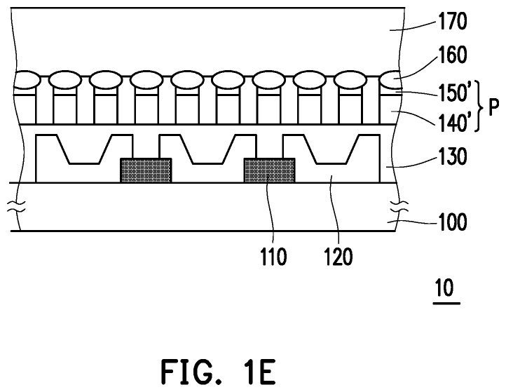

FIG. 1A through FIG. 1E are schematic cross-sectional views of a manufacturing method of a polarizer substrate according to an embodiment of the invention.

Referring to FIG. 1A, a black matrix 110 is formed on the substrate 100. A material of the substrate 100 may be glass, quartz, an organic polymer or a non-transparent/reflective material (e.g., a conductive material, a metal, a wafer, ceramics or any other adaptive material) or any other adaptive material. The black matrix 110 includes a light-shielding material.

A color transferring element 120 is formed on the substrate 100. In some embodiments, the color transferring element 120 includes various colors. For example, the color transferring element 120 includes a red filter element, a green filter element and a blue filter element, and the black matrix 110 is disposed between different color filter elements.

An organic planarization layer 130 is formed on the substrate 100, and the organic planarization layer 130 is disposed on the substrate 100. In the present embodiment, the organic planarization layer 130 is disposed on the black matrix 110 and the color transferring element 120.

A wire-grid material layer 140 is formed above the substrate 100. In the present embodiment, the wire-grid material layer 140 is formed on the organic planarization layer 130. In some embodiments, a buffer layer or other film layers may be further included between the wire-grid material layer 140 and the organic planarization layer 130. In some embodiments, the wire-grid material layer 140 is directly formed on the substrate 100. The wire-grid material layer 140 is made of, for example, an inorganic material or an organic material. In some embodiments, the wire-grid material layer 140 is made of a metal (for example, gold, silver, copper, aluminum, other metals or an alloy of the aforementioned metals).

A capping material layer 150 is formed on the wire-grid material layer 140. The capping material layer 150 is made of, for example, an inorganic material or an organic material. In some embodiments, the capping material layer 150 is made of, for example, an insulation material (for example, silicon oxide, silicon nitride, silicon oxynitride or other insulation materials). In some embodiments, other material layers may be further formed on the capping material layer 150, but the invention is not limited thereto. The material of the wire-grid material layer 140 is different from that of the capping material layer 150.

Patterned photoresist material layer R is formed on the capping material layer 150. The patterned photoresist material layer R includes a plurality of openings O1. In some embodiments, the patterned photoresist material layer R is formed by using a nano-imprint lithography (NIL) technique, but the invention is not limited thereto.

Referring to FIG. 1B, the capping material layer 150 is patterned with the patterned photoresist layer R as masks to form a plurality of strip-shaped capping structures 150′. The strip-shaped capping structures 150′ are, for example, a strip shape (which are, for example, strips extending inwards in FIG. 1B), and an opening O2 is between each two adjacent strip-shaped capping structures 150′. The openings O2 are substantially aligned to the openings O1. Namely, the capping structures 150′ are substantially aligned to the patterned photoresist layer R. In the present embodiment, a method of patterning the strip-shaped capping material layer 150 includes, for example, etching.

Referring to FIG. 1C, first etching is performed on the wire-grid material layer 140 with the strip-shaped capping structures 150′ as masks. In the present embodiment, the first etching is performed on the wire-grid material layer 140 with the strip-shaped capping structures 150′ and the patterned photoresist layer R as masks.

Referring to FIG. 1D, second etching is performed on the wire-grid material layer 140 with the strip-shaped capping structures 150′ as masks to form a plurality of wire-grids 140′. In the present embodiment, the second etching is performed on the wire-grid material layer 140 with the strip-shaped capping structures 150′ and the patterned photoresist layer R as masks. In the present embodiment, a plurality of strip-shaped polarizer structures P are disposed above the substrate 100, each of the strip-shaped polarizer structures P includes the wire-grid 140′ and the strip-shaped capping structure 150′ disposed on the wire-grid 140′. In the present embodiment, the strip-shaped polarizer structures P have a dual-layer structure, but the invention is not limited thereto. In other embodiments, the strip-shaped polarizer structures P may have a structure of three or more layers.

Referring to FIG. 1B through FIG. 1D, an etching rate of the first etching is greater than an etching rate of the second etching. In some embodiments, a ratio of the etching rate of the second etching to the etching rate of the first etching is 0.43 to 0.975. In some embodiments, the etching rate of the first etching is 1.6 nm/sec to 2.4 nm/sec, and the etching rate of the second etching is 1.04 nm/sec to 1.56 nm/sec.

In some embodiments, the etching rates of the first etching and the second etching are controlled by adjusting etching power. For example, the etching power of the first etching is greater than the etching power of second etching.

In the present embodiment, since the etching rate of the second etching is smaller, a plurality of barrier structures 160 are formed on the strip-shaped capping structures 150′ while the second etching is performed. The barrier structures 160 are products formed by reacting an etching gas used during the second etching with a portion of the wire-grid material layer. In other words, when the second etching is performed, a portion of the wire-grid material layer 140 is moved onto the strip-shaped capping structures 150′ and reacted with the etching gas to form the barrier structures 160. A gap W1 between two adjacent barrier structures 160 is smaller than a gap W2 between two adjacent wire-grids 140′. In other embodiments, the gap W1 between two adjacent barrier structures 160 may be 0, in other words, the two adjacent barrier structures 160 may contact with each other. The barrier structures 160 are, for example, a strip shape (which are, for example, strips extending inwards in FIG. 1D).

In some embodiments, a method of performing the first etching and the second etching include applying an etching gas including a protective gas and a reactive gas to the wire-grid material layer 140. The protective gas includes, for example, boron trichloride (BCl₃), carbon tetrachloride (CO₄), trichloromethane (CHCl₃), carbon tetrafluoride (CF₄), chlortrifluoromethane (CHF₃), hexafluoroethane (C₂F₆), fluorotrichloromethane (CFCl₃), chlorotrifluormethane (CClF₃), helium (He), nitrogen (N₂), oxygen (O₂), sulfur hexafluoride (SF₆), silicon tetrachloride (SiCl₄) or a combination of the aforementioned gases. The reactive gas includes, for example, argon (Ar), BCl₃, chlorine (Cl₂), CCl₄, CHCl₃, CF₄, CHF₃, C₂F₆, CFCl₃, CClF₃, He, N₂, O₂, SiCl₄ or a combination of the aforementioned gases. In some embodiments, a range of the reactive gas in a gas flow is 10% to 70%. In some embodiments, a flow ratio of the reactive gas to the protective gas is 0.11 to 2.33.

In some embodiments, the flow ratio of the reactive gas to the protective gas is A/B, and A/B during the first etching is greater than A/B during the second etching. The etching rates of the first etching and the second etching are controlled by adjusting the flow ratio of the reactive gas to the protective gas.

In some embodiments, a material of the barrier structures 160 is different from that of the wire-grid material layer 140, and the material of the barrier structures 160 includes a composite of carbon, hydrogen, nitrogen, oxygen and/or chlorine and the material of the wire-grid material layer 140.

In some embodiments, after the portion of the wire-grid material layer 140 is removed by the first etching to remain 10% to 50% of a thickness, the second etching is performed. In other words, after the first etching is performed, a portion of the wire-grid material layer 140 on which the first etching is not performed has a thickness X1, a portion of the wire-grid material layer 140 on which the first etching is performed has a thickness X2, and X2/X1 is 10% to 50%. Thereby, the wire-grid material layer 140 may be prevented from being incompletely etched.

In the present embodiment, the barrier structures 160 do not contact with side walls SW of the wire-grids 140′, thereby increasing a transmittance and an extinction ratio of the polarizer substrate.

Referring to FIG. 1E, a passivation layer 170 is formed on the barrier structures 160. In the present embodiment, since the gap W1 between each two adjacent barrier structures 160 is smaller, the passivation layer 170 is not filled in gaps between the wire-grids 140′, thereby increasing the transmittance and the extinction ratio of the polarizer substrate 10. In addition, since the passivation layer 170 is not filled in the gaps between the wire-grids 140′, and a thickness of the passivation layer 170 may have preferable flatness.

In some embodiments, a material of the passivation layer 170 includes indium tin oxide, silicon oxide, silicon nitride, organic material or a combination of the aforementioned materials. In some embodiments, an electrode layer and an alignment layer may be further formed on the passivation layer 170, but the invention is not limited thereto.

The polarizer substrate 10 includes the substrate 100, the plurality of strip-shaped polarizer structures P, the plurality of barrier structures 160 and the passivation layer 170. The passivation layer 170 is disposed on the plurality of barrier structures 160′.

Even though in the present embodiment, the polarizer substrate 10 further includes the black matrix 110 and the color transferring element 120, but the invention is not limited thereto. In other embodiments, the polarizer substrate 10 further includes a pixel array, and the polarizer substrate 10 is a pixel array substrate.

In some embodiments, a material of the wire-grids 140′ is different from a material of the strip-shaped capping structures 150′. For example, the material of the wire-grids 140′ includes a metal, and the material of the capping structures 150′ includes silicon oxide, silicon nitride or silicon oxynitride, but the invention is not limited thereto.

In light of the foregoing, the process of etching the wire-grid material layer is divided into two sections in the invention, and thus, the barrier structures having smaller gaps are formed on the strip-shaped polarizer structures. In other words, the barrier structures can be formed on the strip-shaped polarizer structures without any additional coating or deposition process in the invention, thereby obtaining the polarizer substrate with a high transmittance and a high extinction ratio at a lower manufacturing cost.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A polarizer substrate, comprising:
a substrate;
a plurality of strip-shaped polarizer structures, disposed on the substrate, and each of the strip-shaped polarizer structures comprising a wire-grid and a strip-shaped capping structure disposed on the wire-grid;
a plurality of barrier structures, disposed on the strip-shaped capping structures and not contacting with side walls of the wire-grids, wherein a gap between two adjacent barrier structures is smaller than a gap between two adjacent wire-grids; and
a passivation layer, disposed on the barrier structures.

2. The polarizer substrate according to claim 1, wherein the passivation layer is not filled between the wire-grids.

3. The polarizer substrate according to claim 1, wherein a material of the wire-grids is different from a material of the strip-shaped capping structures.

4. The polarizer substrate according to claim 3, wherein the material of the wire-grids comprises a metal.

5. The polarizer substrate according to claim 3, wherein the material of the strip-shaped capping structures comprises silicon oxide, silicon nitride or silicon oxynitride.

6. A manufacturing method of a polarizer substrate, comprising:
forming a wire-grid material layer above a substrate;
forming a capping material layer on the wire-grid material layer;
forming a patterned photoresist layer on the capping material layer;
patterning the capping material layer using the patterned photoresist layer as a mask to form a plurality of strip-shaped capping structures;
performing a first etching on the wire-grid material layer using the strip-shaped capping structures as a masks;
performing a second etching on the wire-grid material layer using the strip-shaped capping structures as masks to form a plurality of wire-grids, and forming a plurality of barrier structures on the strip-shaped capping structures while the second etching is performed, wherein an etching rate of the first etching is greater than an etching rate of the second etching, and a gap between two adjacent barrier structures is smaller than a gap between two adjacent wire-grid; and
forming a passivation layer on the barrier structures.

7. The manufacturing method according to claim 6, wherein a ratio of the etching rate of the second etching to the etching rate of the first etching is 0.43 to 0.975.

8. The manufacturing method according to claim 6, wherein the barrier structures are products formed by reacting an etching gas used during the second etching with a portion of the wire-grid material layer.

9. The manufacturing method according to claim 6, wherein after a portion of the wire-grid material layer is removed by the first etching to remain 10% to 50% of a thickness, the second etching is performed.

10. The manufacturing method according to claim 6, wherein a method of performing the first etching and the second etching comprises applying an etching gas comprising a protective gas and a reactive gas to the wire-grid material layer.

11. The manufacturing method according to claim 10, wherein a flow ratio of the reactive gas to the protective gas is A/B, and A/B during the first etching is greater than A/B during the second etching.

12. The manufacturing method according to claim 6, wherein the barrier structures do not contact with side walls of the wire-grids.
